(19) United States
(12) Patent Application Publication
(10) Pub. No.: US 2013/0325702 A1
(43) Pub. Date: Dec. 5, 2013

(54) Payment System

(71) Applicants: Alexander Morgan Roland Schaefer, McKinnon (AU); Mark Wayne Kuch, Highton (AU)

(72) Inventors: Alexander Morgan Roland Schaefer, McKinnon (AU); Mark Wayne Kuch, Highton (AU)

(73) Assignee: LayPay Pty Ltd., McKinnon (AU)

(21) Appl. No.: 13/595,724

(22) Filed: Aug. 27, 2012

(30) Foreign Application Priority Data
May 29, 2012 (AU) 2012902228

(51) Int. Cl. G06Q 20/10

(52) U.S. Cl. CPC G06Q 20/102
USPC 705/39

(57) ABSTRACT

A payment system for making payments with respect to a plurality of purchases, comprising: a user identifier receiver for receiving a user identifier; a funds transfer data receiver for receiving funds transfer data corresponding to a funds transfer; a purchase data retriever configured to retrieve purchase data with respect to the purchases from purchase data stored in association with respective user identifiers in a memory; a funds transfer value generator configured to generate a plurality of funds transfer values, each one of the funds transfer values corresponding to a respective one of the purchases; a payment value calculator configured to calculate a payment value corresponding to each one of the purchases; and a purchase data modifier configured to modify the purchase data retrieved from the memory, and to output the purchase data as modified.

### RELATED APPLICATION

This application claims the benefit of the priority of Australian provisional application no. 2012902228, the content of which as filed is incorporated by reference in its entirety.

### FIELD

The present invention generally relates to a payment system for making payments with respect to a plurality of purchases. The invention is particularly—but by no means exclusively—related to a payment system for automating the making of voluntary payments with respect to purchases made under lay-by agreements and/or transferring payments between a plurality of purchases made under lay-by agreements.

### BACKGROUND

A “lay-by” (also referred to as “lay-away”) is an agreement between a seller (such as a retailer) and a buyer where the buyer makes a plurality of installment or part payments scheduled over a period of time for a purchase to the seller. Typically, the payments are equal in value, and the time separating each scheduled payment from the next is the same.

A system for purchasing a good by a lay-by agreement is known. To establish a lay-by agreement on the system, a user first provides to the system details of a debit account. Then, the user selects one of a plurality of different payment schedule options generated by the system. The lay-by agreement is established after the user makes the selection. The user cannot change the payment schedule once the lay-by agreement is established on the system. After the lay-by agreement is established on the system, installment payments according to the selected payment schedule are automatically debited by the system from the debit account. It is not possible to make an additional or top-up payment using the system.

There is a need for an alternative or improved system.

### SUMMARY OF THE INVENTION

In a first aspect, the invention provides a payment system for making payments with respect to a plurality of purchases, comprising:

a user identifier receiver for receiving a user identifier (for example, an username and password);

a funds transfer data receiver for receiving from an external computing system funds transfer data corresponding to a funds transfer;

a purchase data retriever configured to retrieve purchase data (for example, data indicative of or related to a payment for a purchase) with respect to the purchases from purchase data stored in association with respective user identifiers in a memory using the user identifier;

a funds transfer value generator configured to generate a plurality of funds transfer values, each one of the funds transfer values corresponding to a respective one of the purchases;

a payment value calculator configured to calculate a payment value corresponding to each one of the purchases based on one or more of the group consisting of the purchase data retrieved from the memory, the funds transfer values and the funds transfer data; and

a purchase data modifier configured to modify the purchase data retrieved from the memory based on one or more of the group consisting of the payment values, the funds transfer values and the funds transfer data, and to output the purchase data as modified.

Persons skilled in the art will appreciate that the term “payment” may mean an voluntary payment that may be equivalent to a part payment (for example, a top-up payment that is less than the outstanding purchase value of a purchase), or a complete payment (that is, a payment that is equivalent in value to the outstanding purchase value of a purchase). Also, persons skilled in the art will appreciate that a purchase may be a good, a service, or a good and a service.

In an embodiment, the purchase data stored in the memory is indicative of or related to a plurality of payment values corresponding to respective purchases.

In an embodiment, each one of the payment values of the purchase data stored in the memory is an installment payment value for purchase, and each one of the payment values calculated by the payment value calculator is a corresponding revised installment payment for purchasing a respective one of the purchases from a retailer.

In an embodiment, the purchase data comprises an installment payment value, an outstanding purchase value and a remaining number of payments value with respect to each one of the purchase, and the purchase data modifier modifies the purchase data, by substituting the payment value of the purchase data with a corresponding revised payment value calculated by the payment value calculator.

In an embodiment, the funds transfer value generator is configured to receive a funds transfer input.

In an embodiment, the funds transfer value generator generates the funds transfer values based on the funds transfer input.

In an embodiment, the system further comprises further comprising a data associator configured to store the purchase data in association with the user identifier in the memory.

In an embodiment, the user identifier receives the user identifier from a user input device.

In an embodiment, the funds transfer data receiver is configured to make a request for the funds transfer data using the user identifier from the user input device.

In an embodiment, the user identifier receiver receives the user identifier by deriving the user identifier from the funds transfer data.

In an embodiment, the funds transfer data receiver is configured to store the funds transfer data in the memory.

In an embodiment, the purchase data comprises payee details.

In an embodiment, the funds transfer data comprises a funds transfer value indicating a value of a funds transfer.

In a second aspect, the invention provides a payment method of making payments with respect to a plurality of purchases using a payment system, comprising:

a user identifier receiver of the payment system receiving a user identifier;

a funds transfer data receiver of the payment system receiving from an external computing system funds transfer data corresponding to a funds transfer;

a purchase data retriever of the payment system retrieving purchase data with respect to the purchases from purchase data stored in association with respective user identifiers in a memory using the user identifier;

a funds transfer value generator of the payment system generating a plurality of funds transfer values, each one of the funds transfer values corresponding to a respective one of the purchases;

a payment value calculator of the payment system calculating a payment value with respect to each one of the purchases based on one or more of the group consisting of the purchase data retrieved from the memory, the funds transfer values and the funds transfer data; and

a purchase data modifier of the payment system modifying the purchase data retrieved from the memory based on one or more of the group consisting of the payment values, the funds transfer values and the funds transfer data, and outputting the purchase data as modified.

In an embodiment, the method further comprises:

a purchase data receiver of the payment system receiving the purchase data with respect to the purchases; and

a data associator of the payment system storing the purchase data in association with the user identifier in the memory.

In an embodiment, the funds transfer value generator is configured to receive a funds transfer input, and the funds transfer value generator generates the funds transfer values based on the funds transfer data.

In a third aspect, the invention provides a system for transferring payments between a plurality of purchases, comprising:

an input for receiving modification data indicative of a first purchase, a second purchase and a payment transfer from the first purchase to the second purchase;

a purchase data retriever configured to retrieve from a memory purchase data with respect to the first and second purchases based on the modification data;

a modification value generator configured to generate first and second modification values based on the modification data;

a payment value calculator configured to calculate first and second payment values based on the purchase data and the first and second modification values; and

a purchase data modifier configured to modify the purchase data with respect to the first and second purchases based on the first and second payment values, the first and second modification values, or the first and second payment values and the first and second modification values, and to output the purchase data as modified.

It is envisaged that the transfer of payments may be between existing purchases or from one or more existing purchases to one or more newly created or added purchases. Hence, the payment system may be configured to enable a user to create or add one or more new purchases.

In an embodiment, each one of the first and second purchases is a good, a service, or a good and a service.

In an embodiment, the purchase data stored in the memory comprises a first installment payment value for purchasing the first purchase and a second installment payment value for purchasing the second purchase.

In an embodiment, the first payment value calculated by the payment value calculator is a revised installment payment value for purchasing the first purchase and the second payment value calculated by the payment value calculator is a revised installment payment value for purchasing the second purchase.

In an embodiment, the purchase data modifier modifies the purchase data, by substituting the first installment payment value of the purchase data with the revised installment payment value for purchasing the first purchase and the second installment payment value of the purchase data with the revised installment payment value for purchasing the second purchase.

In an embodiment, the purchase data comprises a first minimum installment payment value with respect to the first purchase and a second minimum installment payment value with respect to the second purchase.

In an embodiment, the purchase data modifier is configured to determine whether or not the revised installment payment value for purchasing the first purchase is greater than the first minimum installment payment value and whether or not the revised installment payment value for purchasing the second purchase is greater than the second minimum installment payment value

In an embodiment, the purchase data modifier modifies the purchase data in response to a determination that the revised installment payment value for purchasing the first purchase is greater than the first minimum installment payment value and a determination that the revised installment payment value for purchasing the second purchase is greater than the second minimum installment payment value.

In an embodiment, the revised installment payment value for the first purchase is greater than the first installment payment, and the revised installment payment value for the second purchase is smaller than the second installment payment.

In an embodiment, the purchase data modifier is configured to modify the purchase data to indicate that a purchase data modification has been carried out.

In an embodiment, the first modification value is a positive value and the second modification value is a negative value.

In an embodiment, the absolute value of the first modification value is equal to the absolute value of the second modification value.

In a fourth aspect, the invention provides a method of transferring payments between a plurality of purchases using a payment system, comprising:

an input receiver receiving modification data indicative of a first purchase, a second purchase and a payment transfer from the first purchase to the second purchase;

a purchase data retriever retrieving from a memory purchase data with respect to the first and second purchases based on the modification data;

a modification value generator generating first and second modification values based on the modification data;

a payment value calculator calculating first and second payment values based on the purchase data and the first and second modification values; and

a purchase data modifier modifying the purchase data with respect to the first and second purchases based on the first and second payment values, the first and second modification values, or the first and second payment values and the first and second modification values, and outputting the purchase data as modified.

In an embodiment, each one of the first and second purchases is a good, a service, or a good and a service.

In an embodiment, the purchase data stored in the memory comprises a first installment payment value for purchasing the first purchase and a second installment payment value for purchasing the second purchase.

In an embodiment, the first payment value calculated by the payment value calculator is a revised installment payment value for purchasing the first purchase and the second payment value calculated by the payment value calculator is a revised installment payment value for purchasing the second purchase.

In an embodiment, the purchase data modifier modifies the purchase data, by substituting the first installment payment value of the purchase data with the revised installment payment value for purchasing the first purchase and the second installment payment value of the purchase data with the revised installment payment value for purchasing the second purchase.

In an embodiment, the purchase data comprises a first minimum installment payment value with respect to the first purchase and a second minimum installment payment value with respect to the second purchase.

In an embodiment, the method further comprises the purchase data modifier determining whether or not the revised installment payment value for purchasing the first purchase is greater than the first minimum installment payment value and whether or not the revised installment payment value for purchasing the second purchase is greater than the second minimum installment payment value

In an embodiment, the purchase data modifier modifies the purchase data in response to a determination that the revised installment payment value for purchasing the first purchase is greater than the first minimum installment payment value and a determination that the revised installment payment value for purchasing the second purchase is greater than the second minimum installment payment value.

In an embodiment, the revised installment payment value for the first purchase is greater than the first installment payment, and the revised installment payment value for the second purchase is smaller than the second installment payment.

In an embodiment, further comprising the purchase data modifier modifying the purchase data to indicate that a purchase data modification has been carried out.

In an embodiment, the first modification value is a positive value and the second modification value is a negative value.

In an embodiment, the absolute value of the first modification value is equal to the absolute value of the second modification value.

### BRIEF DESCRIPTION OF THE DRAWINGS

In order that the invention may be more clearly ascertained, embodiments will now be described, by way of example, with reference to the accompanying drawings, in which:

FIG. 1 is a schematic diagram of the physical architecture of the payment system according to an embodiment of the invention;

FIG. 2 is a schematic diagram of the functional components of the system of FIG. 1;

FIG. 3 is a schematic diagram of the functional components of an alternative embodiment of the system;

FIG. 4 is a flow chart of a payment method according to an embodiment of the invention, carried out using the system of FIGS. 1 and 2; and

FIG. 5 is a flow chart of a payment method according to an embodiment of the invention, carried out using the alternative embodiment of FIG. 3.

### DETAILED DESCRIPTION OF EMBODIMENTS OF THE INVENTION

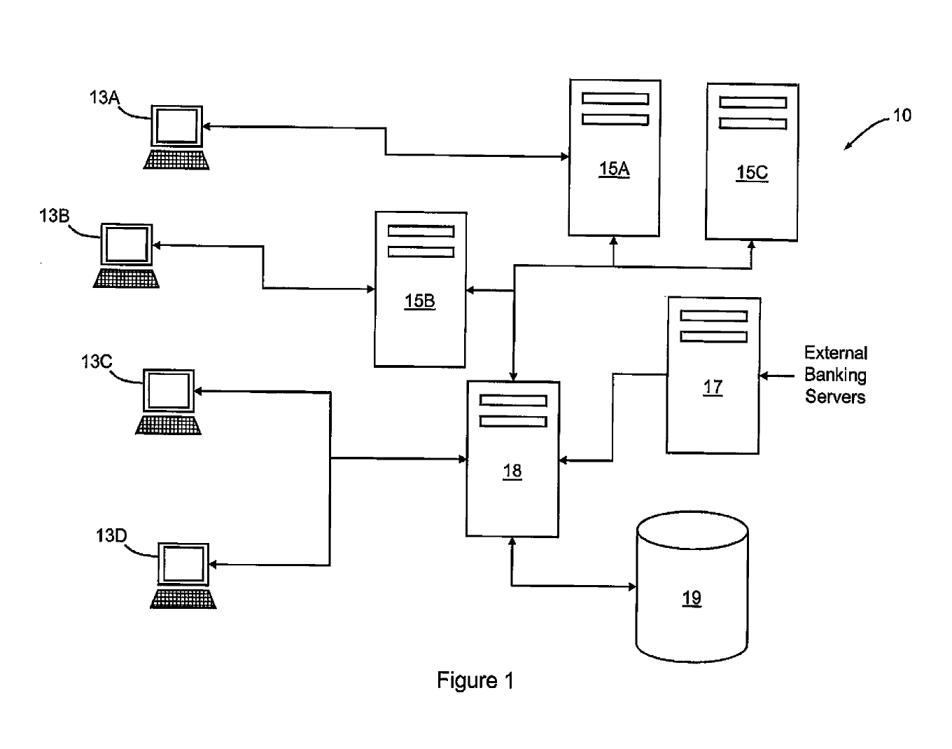

Referring to FIG. 1, there is illustrated a schematic diagram of the physical architecture of a payment system 18 for making one or more payments with respect to a plurality of purchases. Each one of the payments is a voluntary part payment or a voluntary complete payment for purchasing a good, a service, or a good and service under a lay-by agreement (also referred to as a lay-away agreement). Thus, the payment system 18 is advantageous in that it enables a user to pay-off a purchase in a shorter amount of time than that stipulated under the lay-by agreement.

Herein, a payment with respect to a purchase is taken to be made by a user when funds for the payment is transferred to a bank account of the payment system or if funds previously transferred to the bank account of the payment system for the payment with respect to another purchase is subsequently used as the payment with respect to the purchase. Persons skilled in the art will appreciate that the funds may be transferred to the bank account in different ways. For example, the funds transfer may be made electronically by the user through an online banking website implemented by a bank or manually by the user visiting a branch of the bank.

The payment system 18 is in data communication with a plurality of retail computing systems 15. Each one of the retail computing systems 15 is managed by a retailer of goods, services, or goods and services. Two of the retailers have online retail websites. These online retail websites are provided by two of the retail computing systems 15A, 15B. A first user computing device 13A is in data communication with a first one of the two retail computing devices 15A providing the online retail websites. A second user computing device 13B is in data communication with a second one of the two retail computing devices 15B providing the online retail websites. A user operating the first user computing device 13A can make a purchase from the online retail website provided by the first retail computing device 15A using the first user computing device 13A. A user operating the second user computing device 13B can make a purchase from the online retail website provided by the second retail computing device 15B using the second user computing device 13B.

The payment system 18 is connected to a memory in the form of a database 19 for storing data of users of the payment system 18. Examples of the data of users stored in the database 19 includes purchase data (that is, data indicative of or related to a purchase or purchases such as the data indicative of or related to a payment for purchase), fund transfer data (that is, data indicative of or related to a funds transfer or funds transfer) etc. Persons skilled in the art will appreciate that the memory may be implemented as part of an integrated payment system 18 or in a distributed manner (for example, as a database that is remotely connected to the payment system). The payment system 18 is also connected a payment gateway 17 that is in data communication with one or more external banking servers. Funds transfer data corresponding to funds transfers from users can be communicated from the external banking servers to the payment system 18 via the payment gateway 17.

The payment system 18 is also in data communication with two user computing devices 13C, 13D. A user can operate either one of these user computing devices 13C, 13D to cause a payment with respect to a purchase to be made.

The payment system 18 comprises a plurality of functional components for making the payments with respect to the plurality of purchases. The functional components are implemented by a processor of the payment system 18 executing program code stored in a memory of the payment system 18. Persons skilled in the art will appreciate that one or more of the functional components can be implemented in a different way. For example, some or all of the functional components may be alternatively implemented by individual dedicated circuits.

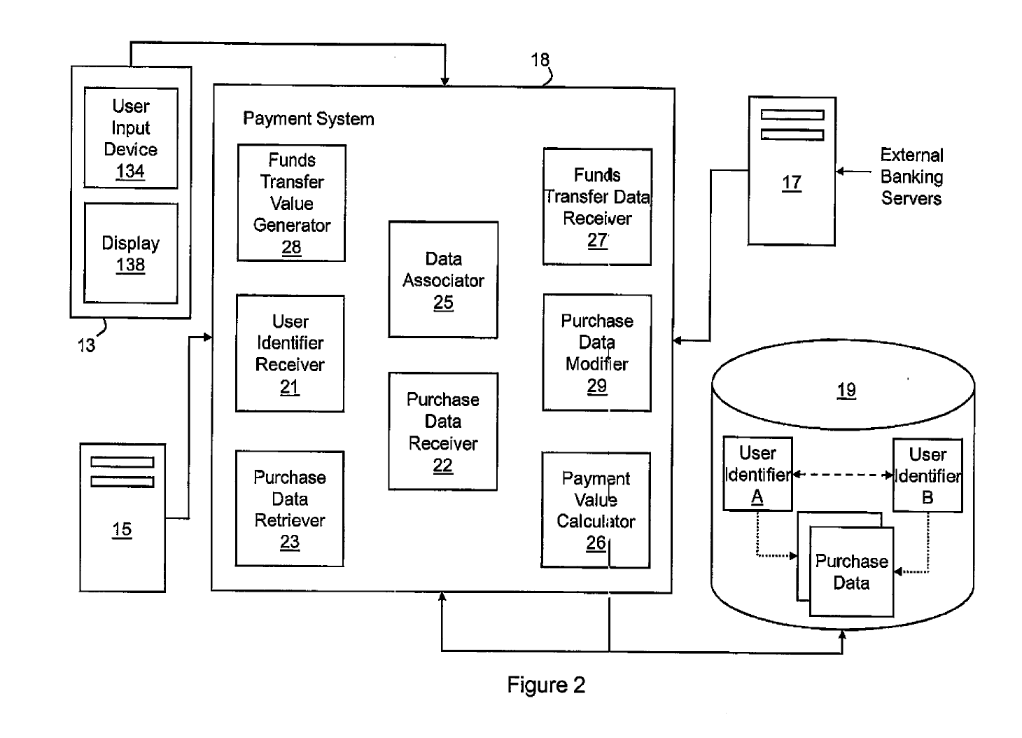

Referring to FIG. 2, one of the functional components of the payment system 18 is a user identifier receiver 21 for receiving a user identifier from a user input device 134 of a user computing device 13. The user identifier is in the form of a username and password. Persons skilled in the art will appreciate that the user identifier may be in a different form in an alternative embodiment. For example, the user identifier may in an alternative embodiment be an alphanumeric code (for example, a barcode received by a barcode reader) representing an account number. Depending on the implementation, the user identifier may be automatically generated by the payment system 18 or manually input into the payment system 18 by a user. Users of the payment system 18 are identified by their user identifiers.

The payment system 18 also comprises a purchase data receiver 22 configured to receive purchase data with respect to the plurality of purchases. The purchase data with respect to a purchase may be received from any one of the retail computing systems 15 connected to the payment system 18. Thus, the purchase data with respect to different purchases may be received from different retail computing systems 18. In this respect, persons skilled in the art will appreciate that the purchase data may be received directly from a retail computing system or indirectly through an intermediary. The purchase data with respect to each one of the purchases comprises an installment payment value, an outstanding purchase value and a remaining number of payments value. Persons skilled in the art will appreciate that the outstanding purchase value may be the price of the purchase, or a different value. For example, the outstanding purchase value may be a value corresponding to the price of the purchase minus an initial deposit payment for the purchase previously made by the user. The remaining number of payments values is the number of payments required to complete the lay-by agreement. Persons skilled in the art will appreciate that the purchase data may not comprise all of an installment payment value, an outstanding purchase value and a remaining number of payments value. For example, in an alternative embodiment, the purchase data may consist only of an installment payment value and a remaining number of payments value. Persons skilled in the art will appreciate that, in such an alternative embodiment, the outstanding purchase value can be derived by multiplying the installment payment value and the remaining number of payments value. Also, persons skilled in the art will appreciate that the purchase data may include additional information or data. For example, the purchase data with respect to each one of the purchases may comprise payee details in the form of the details of the retailer from which the purchase was made.

Another one of the functional components of the payment system 18 is a data associator 25. The data associator 25 is configured to store the user identifier received by the user identifier receiver 21 in association with the purchase data received by the purchase data receiver 23 in a database 19. The data associator 25 enables the payment system to associate the purchase or purchases made by a user to the user. As indicated below, the purchase data associated with the user identifier can be modified after the purchase data is stored in association with the user identifier in the database 19. The purchase data with respect to each one of the purchases may also be stored in association with a purchase identifier in the database 19. This enables the payment system 18 to individually identify each purchase stored in the database 19.

Persons skilled in the art will appreciate that the database 19 may store purchase data with respect to purchases made by a plurality of users. Thus, the database 19 may store purchase data other than the purchase data with respect to the plurality of purchases stored in association with the user identifier.

The payment system 18 also comprises a purchase data retriever 22 configured to retrieve purchase data with respect to one or more purchases from the database 19 using the user identifier received by the user identifier receiver 21. This allows the payment system 18 to retrieve purchase data previously stored in the database 19 by the data associator 25 using just the user identifier. It is envisaged that the database 19 is adapted to store purchase data with respect to a plurality of user identifiers. That is, the database 19 may store the purchase data of a plurality of users. As indicated above, the purchase data associated with a user identifier may be with respect to one or more purchases. A person skilled in the art will appreciate that the database 19 may be initially empty.

Another one of the functional components of the payment system 18 is a funds transfer data receiver 27 for receiving funds transfer data from the payment gateway 17. Depending on the circumstances, the funds transfer data receiver 27 can receive funds transfer data (i) passively by awaiting for funds transfer data or (ii) actively by making a request for the funds transfer data using the user identifier received by the user identifier receiver 27. The funds transfer data may include a user identifier which can be derived by the user identifier receiver 21. That is, the user identifier receiver 21 can receive the user identifier either from the user computing device 13 or the payment gateway 17. It will be appreciated that the user making the funds transfer may not be the user who initially made the purchases. For example, a user may make a funds transfer to make a payment for a purchase made by a friend of the user (for example, by referring to the user identifier of the friend when making the funds transfer).

The payment system 18 also comprises a funds transfer value generator 28 configured to generate a funds transfer value corresponding to each one of the purchases. Each funds transfer value is a percentage value corresponding to the percentage of the funds transfer to be allocated to a respective purchase. Depending on the implementation, the funds transfer value generator 28 may be configured to generate the funds transfer values based on predetermined funds transfer values stored in a memory or based on a funds transfer input received from the user input device 134 of the user computing device 13. In an alternative embodiment, each funds transfer value may be an amount of monies (rather than a percentage) generated based on the funds transfer data.

Another one of the functional components of the payment system 18 is a payment value calculator 26. The payment value calculator 26 is configured to calculate a payment value with respect to each one of the purchases based on the purchase data retrieved from the database 19 using the user identifier received by the user identifier receiver 21. Each payment value is a revised installment payment for purchasing each one of the products. The payment value calculator 26 can calculate the revised installment payment for each one of the products based on one or more of the group consisting of the purchase data retrieved from the memory, the funds transfer values and the funds transfer data. For example, when each of the funds transfer value is an amount of monies (rather than a percentage), the calculation may be performed by subtracting one of the funds transfer values from a respective outstanding purchase value of the purchase data and dividing the result by a respective remaining number of payments value of the purchase data. In another example, when each of the funds transfer value is a percentage, the calculation may be performed by additionally calculating the amount of the monies based on the funds transfer values and the funds transfer data for each of the purchases.

Another one of the functional components of the payment system 18 is a purchase data modifier 29 configured to modify the purchase data retrieved from the database 19 based on one or more of the group consisting of the payment values calculated by the payment value calculator 26, the funds transfer values generated by the funds transfer value generator 28 and the funds transfer data received by the funds transfer data receiver 27. For example, the purchase data modifier 29 may modify the purchase data, by substituting the payment value of the purchase data with a respective revised payment value calculated by the payment value calculator. Persons skilled in the art will appreciate that the value corresponding to the funds transfer value may be a value that is smaller than, equivalent to, or greater than the funds transfer value. For example, the value may be a smaller value to the funds transfer value that is equivalent to the funds transfer value minus a fee. Depending on the funds transfer input received by the funds distribution input receiver 24, the purchase data modifier 29 may make such a modification with respect to only one or some of the purchases. It is envisaged that the purchase data modifier 29 in an alternative embodiment may be configured to additionally or alternatively modify the purchase data by modifying the remaining number of payments values (instead of the outstanding purchase value) with respect to a purchase.

The payment system 18 is also configured to output the purchase data as modified to either the database 19 for storage or the display 138 of the user computing device 13 for display to the user.

It is envisaged that the funds transfer corresponding to the funds transfer data received by the funds transfer data receiver 27 may not be applied completely to the purchase data stored in the database 19. For example, in an embodiment where each funds transfer value is an amount of monies, the total amount of monies corresponding to all of the funds transfer values may be less than the funds transfer corresponding to funds transfer data. In such an example, the unapplied funds may be held in trust for future payments. For example, the data associator 25 may store in the database 19 unapplied funds data corresponding to the unapplied funds in association with the user identifier received by the user identifier receiver 21. Also, it is envisaged that a funds transfer may be received (and thus held in trust) without being applied to the purchase data stored in the database 19. Also, it is envisaged that a portion of a previously applied funds transfer (that is, a previously made payment) may be transferred from one purchase to another purchase.

Also, it is envisaged that the funds transfer data received by the funds transfer data receiver 27 may include a purchase identifier. It is envisaged that, when the funds transfer data includes a purchase identifier, the purchase data modifier 29 modifies the purchase data with respect to only the purchase corresponding to the purchase identifier.

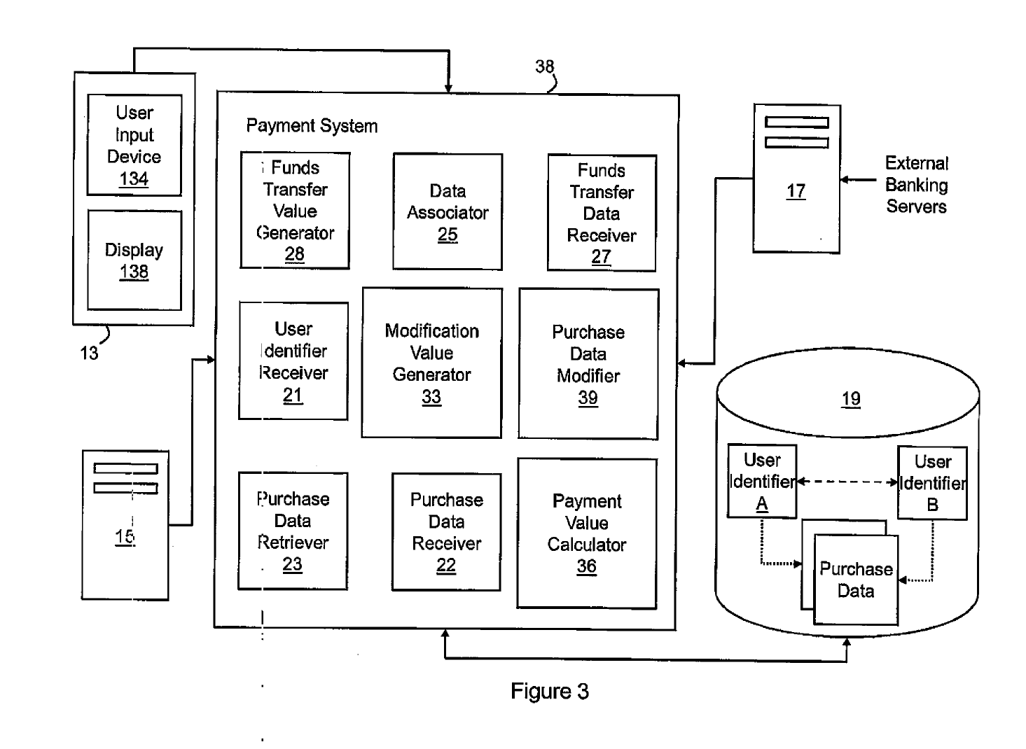

As indicated above, it is envisaged that the payment system 18 may be additionally configured to transfer to a purchase a portion of one or more payments previously made towards another purchase. FIG. 3 illustrates an alternative embodiment of the payment system 18 where the payment system 38 is so additionally configured.

The physical architecture of this alternative embodiment is the same as that of the embodiment of FIG. 1. Also, like the embodiment of FIG. 2, the payment system 38 comprises a user identifier receiver 21 for receiving a user identifier from a user input device 134 of a user computing device 13, a purchase data receiver 22 configured to receive purchase data with respect to a plurality of purchases from a retail computing system 15 connected to the payment system 38, a data associator 25 configured to store a user identifier received by the user identifier receiver 21 in association with purchase data received by the purchase data receiver 23 in a database 19, a purchase data retriever 22 configured to retrieve purchase data with respect to one or more purchases from the database 19 using a user identifier received by the user identifier receiver 21, a funds transfer data receiver 27 for receiving funds transfer data from a payment gateway 17, and a funds transfer value generator 28 configured to generate a funds transfer value corresponding to each one of one or more purchases.

In addition to the components above, the payment system 38 includes an input (that is, a modification data receiver) for receiving from the user input device 134 of the user computing device 13 modification data indicative of a first purchase, second purchase and a payment transfer between the first and second purchases. Example of modification data includes a user identifier (or user identifiers) and/or product identifiers that identifies the first and second purchases, and a numerical value or values that indicates the payment transfer.

The payment system 38 also includes a modification value generator 33 configured to generate first and second modification values based on the modification data received by the input from the user input device 134 of the user computing device 13. The first modification value generated by the modification value generator 33 corresponds to the first purchase. The second modification value generated by the modification value generator 33 corresponds to the second purchase. Each one of the first and second modification values corresponds to either an amount of monies to be deducted from a purchase or an amount of monies to be added to a purchase. In this embodiment, the amount of monies to be deducted is equivalent to the amount of monies to be added. However, it is envisaged that in an alternative embodiment the amount of monies to be deducted may be different from the amount of monies to be added. For example, in an alternative embodiment, the amount of monies to be deducted can be less than the amount of monies to be added, thereby resulting in funds that are unapplied to any purchase. Persons skilled in the art will appreciate that the amount of monies corresponding to each generated modification value may be represented by the payment system 38 in different ways. For example, each generated modification value may be represented by either a negative value or a positive value. Alternatively, each generated modification value may be represented by an amount of monies and a flag indicating whether the amount of monies is to be deducted or added to a purchase.

The payment system 38 also comprises a payment value calculator 36 and a purchase data modifier 39. Like the payment value calculator 26 of the payment system 18 of FIG. 2, the payment value calculator 36 is configured to calculate a payment value with respect to each one of the first and second purchases based on one or more of the group consisting of the purchase data retrieved from the database 19, the funds transfer values and the funds transfer data.

In addition, the payment value calculator 36 is configured to calculate a payment value with respect to each one of the first and second purchases based on the purchase data retrieved from the database 19 and the modification values generated by the modification value generator 33. Like the embodiment of FIG. 2, the purchase data with respect to each purchase stored in the database 19 comprises an installment payment value, an outstanding purchase value and a remaining number of payments value. In addition, the purchase data with respect to each purchase stored in the database 19 comprises a minimum installment payment value. The minimum installment payment value is the initial installment payment value received from the retail computing system 15. The payment value calculator 36 calculates each payment value by adding (or subtracting) one of the modification values from a respective outstanding purchase value of the purchase data and dividing the result by a respective remaining number of payments value of the purchase data.

Like the purchase data modifier 29 of the payment system 18 of FIG. 2, the purchase data modifier 39 is configured to modify the purchase data retrieved from the database 19 based on one or more of the group consisting of the payment values calculated by the payment value calculator 26, the funds transfer values generated by the funds transfer value generator 28 and the funds transfer data received by the funds transfer data receiver 27.

In addition, the purchase data modifier 39 is configured to determine whether or not each one of the minimum installment payment values is greater than a corresponding revised payment value calculated by the payment value calculator 36, and to modify the purchase data retrieved from the database 19 based on the payment values calculated by the payment value calculator 26 and the purchase data in response to a determination that the minimum installment payment values is not greater than the corresponding revised payment value. The purchase data modifier 39 modifies the purchase data by substituting an installment payment value of the purchase data with a corresponding revised payment value calculated by the payment value calculator. Thus, the purchase data modifier 39 modifies the purchase data only if the modification does not result in the installment payment value of the purchase data being less than a minimum installment payment. It is envisaged that the purchase data modifier 39 may be alternatively configured to take into account other factors. For example, the purchase data modifier 39 may be alternatively configured to modify the purchase data only if the corresponding revised payment value calculated by the payment value calculator 36 is greater than the minimum installment payment value by a predetermined margin. In an alternative embodiment, the purchase data modifier 39 may be alternatively configured to modify the purchase data to indicate that a purchase data modification has been carried out (for example, by setting a flag), and to carry out a modification only if no previous modification has been carried out (for example, by determining whether or not the flag is set and carrying out the modification only if it is determined that the flag is not set).

The payment system 18 is also configured to output the purchase data as modified to either the database 19 for storage or the display 138 of the user computing device 13 for display to the user.

In this embodiment, the transfer of payments is made between purchases associated with the same user identifier. However, persons skilled in the art will appreciate that the transfer of payments may be made between purchases associated with the same user identifier or between purchases associated with different user identifiers. It is also envisaged that the transfer of payments may be between more than two purchases, for example, from two or more purchases to another purchase, from one purchase to another two or more purchases, from two or more purchases to another two or more purchases etc.

Also, it is envisaged that an alternative embodiment of the payment system 38 may be modify the outstanding purchase values of purchases rather than the installment payments of purchases.

Also, it is envisaged that in an alternative embodiment, the transfer of payments may involve creating or adding a new purchase or purchases (and hence new purchase data) rather than between existing purchases of a user.

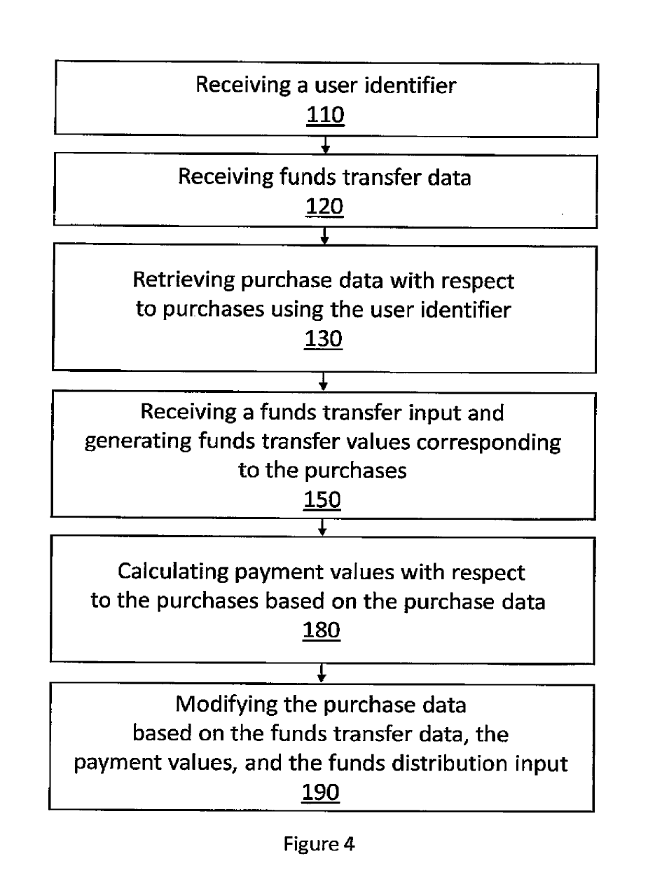

Referring to FIG. 4, there is shown a flow chart of a payment method according to an embodiment of the invention, carried out using the system 18 of FIGS. 1 and 2. At step 110, the user identifier receiver 21 receives a user identifier from a user input device 134 of a user computing device 13. At step 120, the funds transfer data receiver 27 receives funds transfer data from an external banking server via the payment gateway 17. As discussed above, it is envisaged that in an alternative embodiment, the user identifier may be received by the user identifier receiver 21 by deriving the user identifier from the funds transfer data received by the funds transfer data receiver 27 instead of from the user computing device 13.

At step 130, the purchase data retriever 23 retrieves purchase data with respect to a plurality of purchases from the database 19 using the user identifier received by the user identifier receiver 21. At step 150, the funds transfer value generator 28 receives a funds transfer input from the user input device 134 of the user computing device 13 and generates a funds transfer value corresponding to each one of the purchases.

At step 180, the payment value calculator 26 calculates a installment payment value with respect to each one of the purchases based on the purchase data retrieved by the purchase data retriever 23. At step 190, the purchase data modifier 29 modifies the purchase data based on the revised installment payment values calculated by the payment value calculator 26.

The purchase data modified by the purchase data modifier 29 is then output for storage in association with the user identifier in the database 19.

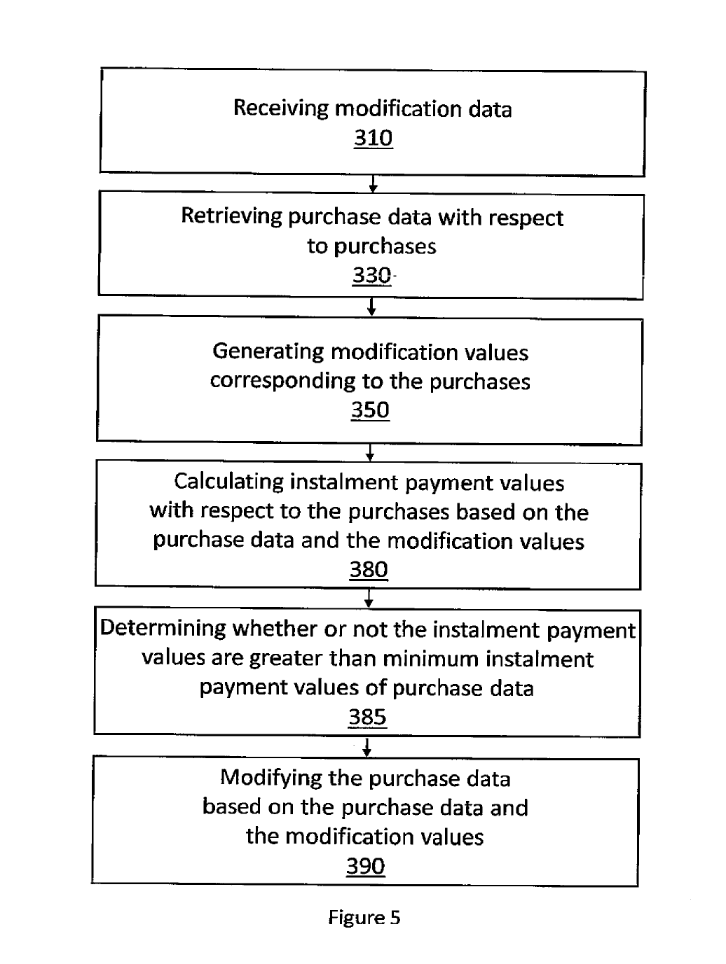

Referring to FIG. 5, there is shown a flow chart of a method of transferring payments between a plurality of purchases according to an embodiment of the invention, carried out using the system 38 of FIG. 3.

At step 310, the input receives modification data from the user input device 134 of the user computing device 13. The modification data is indicative of the purchases and the transfer of payment from one or more of the purchases to one or more of the other purchases.

At step 330, the purchase data retriever 23 retrieves purchase data with respect to a plurality of purchases from the database 19, the purchase data with respect to each one of the purchases including a minimum installment payment value. The purchase data is retrieved based on the modification received by the input.

At step 350, the modification value generator 38 generates a modification value corresponding to each one of the purchases.

At step 380, the payment value calculator 36 calculates a revised installment payment value with respect to each one of the purchases based on the purchase data retrieved by the purchase data retriever 23.

At step 385, the purchase data modifier 39 determines whether or not each one of the revised installment payment values is greater than or equal to a corresponding minimum installment payment value. In this embodiment, the purchase data modifier 39 determines that each one of the revised installment payment values is greater than or equal to the corresponding minimum installment payment value.

At step 390, the purchase data modifier 39 modifies the purchase data based on the revised installment payment values calculated by the payment value calculator 36.

The purchase data modified by the purchase data modifier 39 is then output for storage in association with the user identifier in the database 19.

Further aspects of the method will be apparent from the above description of the payment system. For example, the above description relates to making payments towards purchases under lay-by agreements. However, persons skilled in the art will appreciate that alternative embodiments of the payment system may be used to make payments towards purchases under other agreements such as car loans, health insurance premiums, mortgage repayments etc.

Persons skilled in the art will also appreciate that the method could be embodied in program code. The program code could be supplied in a number of ways, for example on a tangible computer readable medium, such as a disc or a memory (for example, that could replace part of memory 103) or as a data signal (for example, by transmitting it from a server).

Similarly, it will be appreciated that the data in the database can be supplied on any appropriate tangible data carrier, such as by writing them to a portable device (such as a USB drive), storing them in a memory (including transmitting identifiers to a device having a memory) etc.

### Example

An example of the payment system is provided here. Initially, a user registers an account with the payment system using a website provided by the payment system. During the account registration process, the user is provided with a username and a password corresponding to the username. The username and password is used by the payment system as a unique user identifier to identify the account of the user. Banking details of the user is provided by the user to the payment system using the website provided by the payment system.

After registration, the user purchases a good from a retailer using a lay-by service provided by the retailer, and the initial terms (that is, the price of the good, the payment frequency and installment values) of the lay-by agreement between the user and retailer is transmitted from a retail computing system implemented by the retailer to the payment system. These initial terms are used by the payment system to generate purchase data with respect to the purchase. The purchase data includes an installment payment value, an outstanding purchase value and a remaining number of payments value. The purchase data is received by a purchase data receiver of the payment system and stored in association with the user identifier (that is, the username and password) of the account of the user by a data associator of the payment system in a database of the payment system.

Subsequently, the user makes another lay-by purchase from an online website provided by another retail computing system. The initial terms of the second lay-by purchase is transmitted to the payment system via the Internet from the retail computing system and a user computing device operated by the user. The initial terms of the second lay-by purchase is used to generate purchase data with respect to the second purchase. The purchase data with respect to the second purchase is received by the purchase data receiver and stored in association with the user identifier by the data associator in the database of the payment system. The purchase data with respect to the second purchase includes an installment payment value, an outstanding purchase value and a remaining number of payments value.

Then, the user transfers funds from a bank account to the payment system to make a voluntary additional or top-up payment for the first and second lay-by purchases. When the user makes the funds transfer, funds transfer data corresponding to the funds transfer is transmitted from an external banking system to the payment system via a payment gateway. The funds transfer data is received by a funds transfer retriever of the payment system. The funds transfer is made by the user using a user computing device. The funds transfer data includes the amount of funds (or monies) transferred and the username of the user.

Upon receiving the funds transfer data, a purchase data of the payment system retrieves from the database of the payment system, the purchase data of the first and second purchases using the user identifier from the funds transfer data. Also, a funds transfer value generator of the payment system generates a funds transfer value corresponding to each one of the first and second purchases. Each one of the funds transfer value is a percentage value indicating a percentage of the funds transfer.

Then, a payment value calculator of the payment system calculates a modified installment payment value for each one of the first and second purchases based on the retrieved purchase data and the funds transfer data. Specifically, the payment system calculates the modified installment payment values, by first deducting a value equivalent to a percentage of the funds transfer from the outstanding purchase value of each one of the first and second purchases and then dividing the result by the remaining number of payments value. The percentage of the funds transfer for each of the purchases is specified by the funds transfer value corresponding to the purchase.

After the modified installment payment values for the first and second purchases are calculated, a purchase data modifier of the payment system modifies the purchase data retrieved from the database, by substituting the installment payment vales with the modified installment payment values. Then, the modified purchase data are transmitted to the database of the payment system to update the purchase data with respect to the first and second purchases stored in the database.

Subsequently, the user logins into the website provided by the payment system and schedules another additional payment for each one of the first and second purchases, by scheduling using the payment system a funds transfer from the account corresponding to the banking details provided by the user during registration. During the scheduling process, a funds transfer input indicating that 80% of the funds transfer is to be allocated to the first purchase and 20% of the funds transfer is to be allocated to the second purchase is received by the funds transfer value generator. Upon the day of the scheduled additional payments, the payment makes a request for the scheduled funds transfer using the banking details provided by the user during registration. Upon receiving the funds transfer data, the purchase data retriever retrieves purchase data with respect to the first and second purchases and the funds transfer value generator generates a funds transfer value of 80% with respect to the first purchase and a funds transfer value of 20% with respect to the second purchase. Then the payment value calculator calculates modified installment values based on the retrieved purchase data, the generated funds transfer values and the received funds transfer data. Subsequently, the purchase data modifier modifies the installment values of the retrieved purchase data and outputs the modified purchase data for storage in the database.

The payment system also periodically checks the database of the payment system to determine whether an installment payment or payments is required to be made with respect to the purchase data stored in the database. If a payment is required to be made with respect to one of the purchases, the payment system automatically deducts the required installment payment from the account of the user (for example, by deducting any unapplied funds associated with the user identifier, by sending a request for funds—such as in the form of an Short Messaging Service (SMS) message—to a user and subsequently receiving a funds transfer, or by using the banking details provided by the user during registration). Specifically, the payment system first makes a request for required installment payment using the using the banking details provided by the user during registration. Upon receipt of funds transfer data corresponding to the required installment payment, the payment system retrieves the purchase data corresponding to the purchase from the database of the payment system, modifies the remaining number of payments value of the purchase data to reflect that a required installment payment has been made, and then transmits the modified purchase data to the database of the payment system to update the purchase data with respect to the purchase stored in the database.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference made herein to prior art is not intended to imply that such prior art forms or formed a part of the common general knowledge in Australia or any other country.

1. A payment system for making payments with respect to a plurality of purchases, comprising:
a user identifier receiver for receiving a user identifier;
a funds transfer data receiver for receiving from an external computing system funds transfer data corresponding to a funds transfer;
a purchase data retriever configured to retrieve purchase data with respect to the purchases from purchase data stored in association with respective user identifiers in a memory using the user identifier;
a funds transfer value generator configured to generate a plurality of funds transfer values, each one of the funds transfer values corresponding to a respective one of the purchases;
a payment value calculator configured to calculate a payment value corresponding to each one of the purchases based on one or more of the group consisting of the purchase data retrieved from the memory, the funds transfer values and the funds transfer data; and
a purchase data modifier configured to modify the purchase data retrieved from the memory based on one or more of the group consisting of the payment values, the funds transfer values and the funds transfer data, and to output the purchase data as modified.

2. (canceled)

3. A system as claimed in claim 1, wherein the purchase data stored in the memory is indicative of or related to a plurality of payment values corresponding to respective purchases.

4. A system as claimed in claim 3, wherein each one of the payment values of the purchase data stored in the memory is an installment payment value for purchase, and each one of the payment values calculated by the payment value calculator is a corresponding revised installment payment for purchasing a respective one of the purchases from a retailer.

5. A system as claimed in claim 4, wherein the purchase data comprises an installment payment value, an outstanding purchase value and a remaining number of payments value with respect to each one of the purchases, and the purchase data modifier modifies the purchase data, by substituting the payment value of the purchase data with a corresponding revised payment value calculated by the payment value calculator.

6. A system as claimed in claim 1, wherein the funds transfer value generator is configured to receive a funds transfer input and the funds transfer value generator generates the funds transfer values based on the funds transfer input.

7. (canceled)

8. A system as claimed in claim 1, further comprising:
a purchase data receiver for receiving the purchase data with respect to the purchases; and
a data associator configured to store the purchase data in association with the user identifier in the memory.

9. (canceled)

10. A system as claimed in claim 1, wherein the user identifier receives the user identifier from a user input device and the funds transfer data receiver is configured to make a request for the funds transfer data using the user identifier from the user input device.

11. (canceled)

12. A system as claimed in claim 1, wherein the user identifier receiver receives the user identifier by deriving the user identifier from the funds transfer data.

13. A system as claimed in claim 1, wherein the funds transfer data receiver is configured to store the funds transfer data in the memory.

14. A system as claimed in claim 1, wherein the purchase data comprises payee details, the funds transfer data comprises a funds transfer value indicating a value of a funds transfer, and the funds transfer corresponds to a voluntary payment.

15. (canceled)

16. (canceled)

17. A payment method of making payments with respect to a plurality of purchases using a payment system, comprising:
a user identifier receiver of the payment system receiving a user identifier;
a funds transfer data receiver of the payment system receiving from an external computing system funds transfer data corresponding to a funds transfer;
a purchase data retriever of the payment system retrieving purchase data with respect to the purchases from purchase data stored in association with respective user identifiers in a memory using the user identifier;
a funds transfer value generator of the payment system generating a plurality of funds transfer values, each one of the funds transfer values corresponding to a respective one of the purchases;
a payment value calculator of the payment system calculating a payment value with respect to each one of the purchases based on one or more of the group consisting of the purchase data retrieved from the memory, the funds transfer values and the funds transfer data; and
a purchase data modifier of the payment system modifying the purchase data retrieved from the memory based on one or more of the group consisting of the payment values, the funds transfer values and the funds transfer data, and outputting the purchase data as modified.

18. (canceled)

19. (canceled)

20. (canceled)

21. A system for transferring payments between a plurality of purchases, comprising:
an input for receiving modification data indicative of a first purchase, a second purchase and a payment transfer from the first purchase to the second purchase;
a purchase data retriever configured to retrieve from a memory purchase data with respect to the first and second purchases based on the modification data;
a modification value generator configured to generate first and second modification values based on the modification data;
a payment value calculator configured to calculate first and second payment values based on the purchase data and the first and second modification values; and
a purchase data modifier configured to modify the purchase data with respect to the first and second purchases based on the first and second payment values, the first and second modification values, or the first and second payment values and the first and second modification values, and to output the purchase data as modified.

22. (canceled)

23. A system as claimed in claim 21, wherein the purchase data stored in the memory comprises a first installment payment value for purchasing the first purchase and a second installment payment value for purchasing the second purchase, and the first payment value calculated by the payment value calculator is a revised installment payment value for purchasing the first purchase and the second payment value calculated by the payment value calculator is a revised installment payment value for purchasing the second purchase.

24. (canceled)

25. A system as claimed in claim 23, wherein the purchase data modifier modifies the purchase data, by substituting the first installment payment value of the purchase data with the revised installment payment value for purchasing the first purchase and the second installment payment value of the purchase data with the revised installment payment value for purchasing the second purchase.

26. A system as claimed in claim 25, wherein the purchase data comprises a first minimum installment payment value with respect to the first purchase and a second minimum installment payment value with respect to the second purchase, and the purchase data modifier is configured to determine whether or not the revised installment payment value for purchasing the first purchase is greater than the first minimum installment payment value and whether or not the revised installment payment value for purchasing the second purchase is greater than the second minimum installment payment value.

27. (canceled)

28. A system as claimed in claim 26, wherein the purchase data modifier modifies the purchase data in response to a determination that the revised installment payment value for purchasing the first purchase is greater than the first minimum installment payment value and a determination that the revised installment payment value for purchasing the second purchase is greater than the second minimum installment payment value.

29. A system as claimed in claim 23, wherein the revised installment payment value for the first purchase is greater than the first installment payment, and the revised installment payment value for the second purchase is smaller than the second installment payment.

30. A system as claimed in claim 21, wherein the purchase data modifier is configured to modify the purchase data to indicate that a purchase data modification has been carried out.

31. A system as claimed in claim 21, wherein the first modification value is a positive value and the second modification value is a negative value, and the absolute value of the first modification value is equal to the absolute value of the second modification value.

32. (canceled)

33. A method of transferring payments between a plurality of purchases using a payment system, comprising:
an input receiving modification data indicative of a first purchase, a second purchase and a payment transfer from the first purchase to the second purchase;
a purchase data retriever retrieving from a memory purchase data with respect to the first and second purchases based on the modification data;
a modification value generator generating first and second modification values based on the modification data;
a payment value calculator calculating first and second payment values based on the purchase data and the first and second modification values; and
a purchase data modifier modifying the purchase data with respect to the first and second purchases based on the first and second payment values, the first and second modification values, or the first and second payment values and the first and second modification values, and outputting the purchase data as modified.

34. (canceled)

35. (canceled)

36. (canceled)

37. (canceled)

38. (canceled)

39. (canceled)

40. (canceled)

41. (canceled)

42. (canceled)

43. (canceled)

44. (canceled)
